(19) United States
(12) Patent Application Publication
(10) Pub. No.: US 2005/0102254 A1
(43) Pub. Date: May 12, 2005

(54) Methods, computer program products, and systems that schedule loading data into databases

(76) Inventors: Gary William Marr, Marietta, GA (US); Jane Barbara Nowak, Marietta, GA (US); Leonid Volozhanin, Lilburn, GA (US)

Correspondence Address: David K. Purks;Myers Bigel Sibley & Sajovec, P.A., P.O. Box 37428, Raleigh, NC, 27627, US

(21) Appl. No.: 10/702,283

(22) Filed: Nov. 6, 2003

(51) Int. Cl. G06F 7/00

(52) U.S. Cl. 707/1

(57) ABSTRACT

Data is automatically loaded into a user database from an external data source based on a schedule. A determination is made as to whether a task schedule has been satisfied. An application database and the user database are opened using a batch process based on the determination. A macro may be used to load data from an external data source into the user database. A task scheduler may be used to invoke the batch process. The application database may be an Access application database. The macro may remove data from predefined fields in the user database, and then may load data from the external data file into at least some of the predefined fields of the user database. The macro may be used to quit the user database and the application database after the data is loaded into the user database.

### FIELD OF THE INVENTION

This invention relates generally to data processing systems and, more particularly, to methods and systems for loading data into databases.

### BACKGROUND OF THE INVENTION

Databases are widely used on computers to store and retrieve data. One widely used database is Access by Microsoft Corporation. In some business operations, users may be required to update a computer database by loading data from an external file. Such database updating may be time consuming and may necessitate that users be specially trained on database processes and that they be given special computer access privileges. SUMMARY OF THE INVENTION

Some embodiments of the present invention provide a method of loading data into a user database. A determination is made as to whether a task schedule has been satisfied. A user database and an application database are opened based on the determination, and data is loaded from an external data source into the user database. In various other embodiments of the present invention, a batch process may be invoked from a task scheduler. The batch process may include batch code that opens the application database and opens the user database within the application database, and provides a pointer to a macro that contains instructions for loading data into the user database. Data may be removed from predefined fields in the user database, and then data may be loaded from the external data source into at least some of the predefined fields of the user database. The macro may then quit (i.e., shut-down) the user database, and may also quit the application database.

The loading of data into a user database may thereby be scheduled, and may be performed in an automated manner. For example, a user database may be updated with data from an external data source, such as a file, before the start of a user's work-shift. Because the user database may be automatically updated, users may not need to be specially trained on the operation of the application database and/or the user database, and/or may not need to be given special computer access privileges.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram of a system that automatically loads data from an external data source into a database based on a schedule according to various embodiments of the present invention.

FIG. 2 is a flowchart that illustrates operations that may be performed to load data into the database according to various embodiments of the present invention.

FIG. 3 is a flowchart that illustrates operations that may be performed to update data fields in a database according to various embodiments of the present invention.

FIG. 4 is a block diagram of a computer system according to various embodiments of the present invention.

### DETAILED DESCRIPTION

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numerals refer to like elements throughout.

As will be appreciated by one of skill in the art, the present invention may be embodied as methods and/or computer program products. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language. The program code may execute entirely on a user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, systems and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

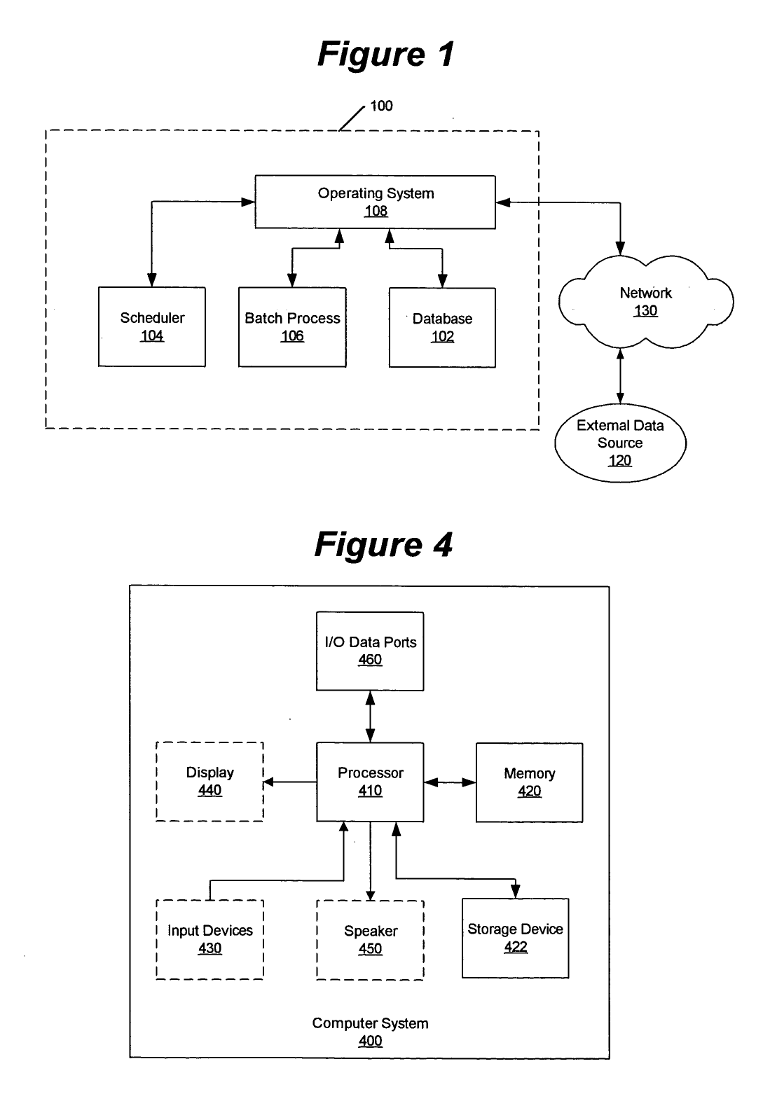

FIG. 1 illustrates a system according to various embodiments of the present invention that includes a data processing system 100 that is interconnected to an external data source 120 by a network 130. The network 130 may be, for example, a wired and/or wireless local area network and/or wide area network. Although the external data source 120 is shown as separate from the data processing system 100, it may instead be at least partially within the data processing system 100. The data processing system 100 may include a database 102, a scheduler 104, a batch process 106, and an operating system 108 that controls execution and/or communication among these components. The operating system 108 may be any operating system suitable for use with a data processing system, such as Windows95, Windows98, Windows2000, Windows NT, Windows ME, Windows XP from Microsoft Corporation, Unix, Linux, OS/2, AIX or System390 from International Business Machines Corporation, Armonk, N.Y. Although the scheduler 104 is shown as separate from the operating system 108, it is to be understood that it may be at least partially within the operating system 108. The scheduler 104 may include the Scheduled Task program of the Windows operating system.

The database 102 may be an Access application database and a user database. The Access application database is configured to access the user database and to associate data in the user database with defined fields. The batch process 106 is configured to load data from the external data source 120 through the Access application database into define fields within the user database. The scheduler 104 is configured to invoke the batch process 106 to load the data into the user database portion of the database 102 based on a defined schedule, which may be based on, for example, time of day and/or based on the day of a week, month, and/or year.

The operating system 108 may also restrict users to predefined access privileges. For example, a database administrator may have sufficient access privileges to modify when the scheduler 104 initiates the loading of data into the database 102, to modify the identity of the external data source 120, and/or to modify where the data is loaded into the database 102. In contrast, a person who is responsible for using data in the user database portion of the database 102 may, for example, be prohibited from modifying the scheduler 104 and/or batch process 106.

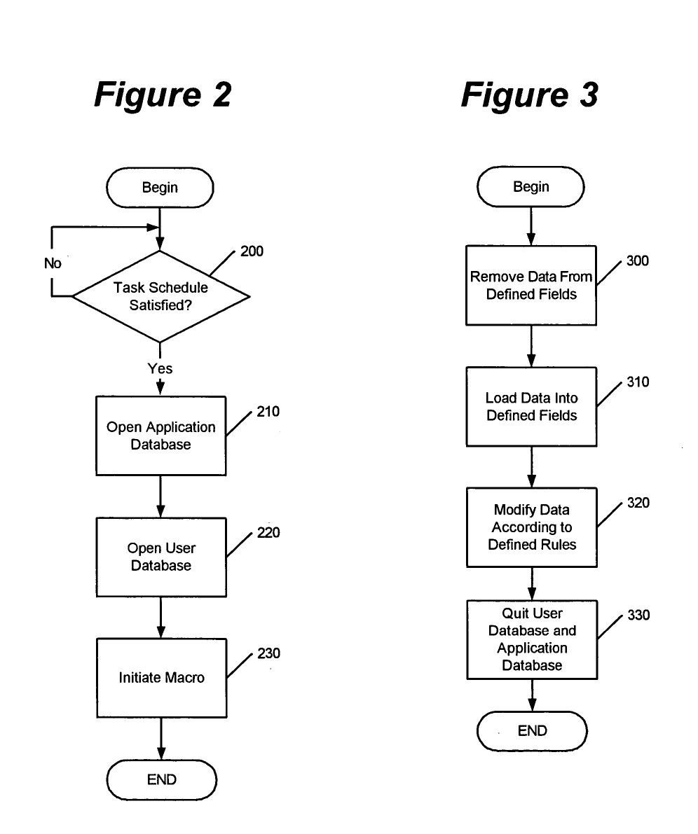

FIG. 2 shows operations that may be performed to load data into the database 102 according to a schedule. For purposes of illustration only, the scheduler 104 is the Windows Scheduled Task program, and the database 102 includes an Access application database and an associated user database. At Block 200, the Scheduled Task program determines whether the task schedule has been satisfied, and when it has been satisfied, it invokes a batch process that contains batch code (i.e., instructions) for opening the Access application, for opening the user database, for initiating a macro that is performed on the user database. The schedule which may be based on, for example, time of day and/or based on the day of a week, month, and/or year. At Block 210 the batch process opens the Access application database. At Block 220, the batch process opens the user database. At Block 230, the batch process initiates the Macro that is to be performed on the user database. Although Blocks 210-230 are shown as three operations, they may be performed by one or more batch code instructions. For example, a batch process in a Windows Scheduled Task program may open an Access application database called “MSACCESS.EXE”, open an user database file named “Datamain.mdb”, and initiate a macro named “Main”, using the following command:
C: CD\Program Files\Microsoft Office\MSACCESS.EXE C:\Datamain.mdb /X Main.

FIG. 3 shows operations that may be performed by the macro within the Access application database to load data from the external data source 120 into the user database and then to quit the user database and the Access application database. At Block 300, data is removed from defined fields of the user database. At Block 310, data is loaded from the external data source 120 into at least some of the defined fields in the user database. At Block 320, the loaded data may be modified according to defined rules. For example, portions of data in some predefined fields may be modified and/or moved to other fields according to predefined rules. At Block 330, the user database and the Access application databases are quitted using, for example, a “QUIT” command, to thereby shut-down the database 102. Alternatively, at Block 330, the user database may be quitted without quitting the Access application database using, for example, a “CLOSE” command.

Accordingly, a database may be opened, loaded with data, and quitted in an automated manner. Data may be loaded into the database according to a defined schedule. For example, a database may be updated with data from an external data source, such as a file, before the start of a user's work-shift. The database may thereby provide a user with updated data when the user is ready to begin using the database. Because the database may be automatically updated, users may not need to be specially trained on the operation of the database, and/or may not need to be given special computer access privileges.

FIG. 4 illustrates an exemplary embodiment of a computer or data processing system 400 that is suitable for use as the data processing system 100 of FIG. 1 in accordance with various embodiments of the present invention. The data processing system 400 typically includes a processor 410 that communicates with a memory 420 and a storage device 422. The data processing system 400 may, optionally, include input device(s) 430 such as a keyboard or keypad, and a display 440 (illustrated in dashed lines) that also communicate with the processor 410. The data processing system 400 may further include optional devices such as a speaker 450, and an I/O data port(s) 460 that also communicate with the processor 410. The I/O data ports 460 can be used to transfer information between the data processing system 400 and another computer system, a network, and/or a peripheral device such as a printer. These components may be conventional components such as those used in many conventional data processing systems which may be configured to operate as described herein.

The processor 410 can be any commercially available or custom microprocessor. The memory 420 is representative of the overall hierarchy of memory devices containing the software and data used to implement the functionality of the data processing system 400. The memory 420 can include, but is not limited to, the following types of devices: cache, ROM, PROM, EPROM, EEPROM, flash memory, SRAM, and DRAM. The storage device 422 may be one or more mass-data storage devices, including, but not limited to, one more magnetic (e.g., hard disk), optical (e.g., CD and/or DVD), and/or magneto-optical storage devices. The memory 420 may include several categories of software and data used in the data processing system 400: an operating system; application programs; input/output (I/O) device drivers; and data. The I/O device drivers typically include software routines accessed through the operating system by the application programs to communicate with devices such as the I/O data port(s) 460 and certain memory 420 components. The application programs are illustrative of the programs that implement the various features of the data processing system 400 and preferably include at least one application which supports operations according to embodiments of the present invention.

In the drawings and specification, there have been disclosed embodiments of the invention and, although specific terms are employed, they are used in a generic and descriptive sense only and not for purposes of limitation, the scope of the invention being set forth in the following claims.

1. A method of loading data into a user database, the method comprising:
determining that a task schedule has been satisfied;
opening an application database and a user database using a batch process based on the determination that the task schedule has been satisfied;
loading data from an external data source into the user database using a macro; and
quitting the user database using the macro.

2. The method of claim 1, further comprising quitting the application database using the macro.

3. The method of claim 1, wherein determining that the task schedule has been satisfied comprises monitoring time of day relative to a scheduled time.

4. The method of claim 1, wherein determining that the task schedule has been satisfied comprises monitoring day of week relative to a scheduled day.

5. The method of claim 1, wherein opening the application database and the user database using the batch process based on the determination that the task schedule has been satisfied comprises:
invoking the batch process from a task scheduler; and
opening the application database and the user database using batch code from the batch process.

6. The method of claim 5, wherein loading data from the external data source into the user database comprises opening the user database with a pointer to the macro that contains instructions for loading data from the external data source.

7. The method of claim 5, further comprising defining a schedule for invoking the batch process in a Scheduled Task program of Microsoft Windows.

8. The method of claim 5, wherein opening the application database and the user database from the batch process comprises identifying a path to an executable program for the application database and a path to a user database file.

9. The method of claim 1, wherein loading data from the external data source into the user database comprises:
removing data from predefined fields in the user database; and
loading data from the external data source into at least some of the predefined fields.

10. The method of claim 9, wherein loading data from the external data source into the database further comprises generating data in other predefined fields based on the data from the external data source.

11. A computer program product for loading data into a user database, the computer program product comprising program code embodied in a computer-readable storage medium, the computer program code comprising:
program code that is configured to determine that a task schedule has been satisfied;
program code that is configured to open an application database and a user database based on the determination that the task schedule has been satisfied;
program code that is configured to load data from an external data source into the user database; and
program code that is configured to quit the user database.

12. The computer program product according to claim 11, further comprising program code that is configured to quit the user database using macro instructions and to quit the application database using the macro instructions.

13. The computer program product according to claim 11, wherein the program code that is configured to open the application database and the user database comprises:
program code that is configured to invoke a batch process from a task scheduler; and
program code that is configured to open the application database and the user database from the batch process.

14. The computer program product according to claim 13, wherein the program code that is configured to open the application database and the user database from the batch process comprises program code that is configured to open a Microsoft Access application database and a user database file.

15. The computer program product according to claim 11, wherein the program code that is configured to load data from an external data source into the user database comprises:
program code that is configured to remove data from predefined fields in the user database; and
program code that is configured to load data from the external data source into at least some of the predefined fields.

16. A data processing system comprising:
an application database that is configured to access a user database;
a user database that comprises data fields;
a data source that is external to the application database and the user database, and that comprises data;
a macro that is configured to load data from the data source through the application database into the user database, and that is configured to quit the user database;
a batch process that is configured to open the application database, and is configured to open the user database, and is configured to initiate the macro; and
a scheduler that is configured to invoke the batch process when a task schedule has been satisfied.

17. The data processing system of claim 16, wherein the macro is configured to quit the application database.

18. The data processing system of claim 16, wherein the batch process is configured to load data from the data source into predefined fields of the user database.

19. The data processing system of claim 16, wherein the batch process is configured to quit the user database and to quit the application database after data is loaded from the data source into the user database.

20. The data processing system of claim 16, wherein the batch process is configured to open the user database with a pointer to the macro to be executed by the application database.
